(19) United States
(12) Patent Application Publication
(10) Pub. No.: US 2008/0129462 A1
(43) Pub. Date: Jun. 5, 2008

(54) MAGNETIC COMPOSITE MATERIALS AND ARTICLES CONTAINING SUCH

(75) Inventors: Eric Vignola, Aliquippa, PA (US); Richard J. Burns, Leominster, MA (US)

Correspondence Address: NOVA Chemicals Inc., Westpointe Center, 1550 Coraopolis Heights Road, Moon Township, PA, 15108, US

(73) Assignee: NOVA CHEMICALS INC., Moon Township, PA (US)

(21) Appl. No.: 11/954,592

(22) Filed: Dec. 12, 2007

Related U.S. Application Data
(63) Continuation-in-part of application No. PCT/US2006/025285, filed on Jun. 29, 2006.
(60) Provisional application No. 60/695,465, filed on Jun. 30, 2005.

(51) Int. Cl. H04Q 5/22; B65D 85/57; H01F 1/00; B32B 7/02

(52) U.S. Cl. 340/10.1; 206/307; 428/692.1; 428/220

(57) ABSTRACT

Composite materials that include a resin containing a polymer obtained by polymerizing a monomer mixture that contains at least one polymerizable monomer and a magnetic material, where the composite material can be used to make sheet stock and articles, such as storage containers. The composite materials can be made by mechanical milling the magnetic material into the resin or by using bulk, suspension, emulsion, mini-emulsion or micro-emulsion polymerization techniques where the resin is formed in the presence of the magnetic material. Articles made of the composite material can be used in a method of deterring theft of an article which includes providing the above-described container, applying a magnetic field to an interrogation zone, causing movement of the container into the interrogation zone, and detecting a magnetic response resulting from the container moving into the interrogation zone.

### REFERENCE TO RELATED APPLICATION

This application is a Continuation-In-Part of International Application No. PCT/US2006/025285, filed Jun. 29, 2006, entitled “Magnetic Composite Materials And Articles Containing Such”, which claims the benefit of priority of U.S. Provisional Application Ser. No. 60/695,465 filed Jun. 30, 2005, entitled “Magnetic Composite Materials And Articles Containing Such”, which are both herein incorporated by reference in their entirety.

### BACKGROUND OF THE INVENTION

1. Field of the Invention

The present invention is directed to composite materials having magnetic properties, sheets containing such composite materials, and articles, in some instances storage containers containing magnetic composite materials.

2. Description of the Prior Art

A number of passive data tag systems are known in the art. As an example, data tags referred to as barcodes, which are based on optically-read printed patterns of lines are well known. Barcode systems are low-cost, typically requiring only ink and paper. The readers are also relatively low cost, typically employing scanning laser beams. For many major applications the only real drawback to barcode systems is the need for line-of-sight between the reader and the tag.

For applications where line-of-sight is not possible, systems not employing optical transmission have been developed. One such system employs magnetic induction for coupling between the tag and the interrogator electronics. These applications typically operate with alternating magnetic fields in the frequency range of 50 kHz to 1 MHz, and generally employ integrated electronic circuits (“chips”) to handle, receive and transmit functions, and to provide data storage and manipulation. In order to avoid the need for a battery, power for the chip is obtained by rectification of the interrogating signal received by an antenna coil. In order to increase the power transferred, and to provide discrimination against unwanted signals and interference, the coil is usually resonated with a capacitor at the frequency of the interrogation signal carrier frequency.

Other multi-bit data tag systems employ conventional high frequency radio technology, or technologies based on surface acoustic waves or magnetostriction phenomena.

A particular system described in U.S. Pat. No. 6,144,300 utilizes magnetic tags or markers together with a variety of techniques by means of which such tags may be interrogated. As an example, the magnetic marker or tag can be characterized as carrying a plurality of discrete magnetically active regions in a linear array, which provides a method of interrogating a magnetic tag or marker within a predetermined interrogation zone.

Many of the methods described above are used as theft deterrent devices and/or methods for use with storage containers or “jewel boxes” used to store compact disks (CDs) and digital video disks (DVDs). U.S. Pat. No. 5,573,120 provides a description of such storage containers and is herein incorporated by reference.

U.S. Pat. No. 7,219,362 discloses storage containers with a barcode or RFID tag affixed to a wall of the container.

A drawback to the above-described methods is that they typically require affixing a label or magnetic tag or identifier to an article, which can be removed. Many methods have been devised to make removal difficult, but nonetheless, once the labels or tags are removed the systems based on their presence fail.

Thus, there is a need in the art to provide a data and/or security system for pilferable articles in which it would be difficult, if not impossible to remove a marker without seriously damaging the article.

### SUMMARY OF THE INVENTION

The present invention provides composite materials that include a resin containing a polymer, obtained by polymerizing a monomer mixture that contains at least one polymerizable monomer, and a magnetic material.

The present invention also provides sheet stock made from the above-described composite material.

The present invention further provides a storage container that incorporates box containing components that include a bottom tray and a cover, the cover being movable between alternative open and closed positions relative to the bottom tray, where at least a portion of at least one of the components includes the above-described composite material.

The present invention is also directed to methods of making the above-described composite material, which can include mechanical milling the magnetic material into a resin or by using bulk, suspension, emulsion, mini-emulsion or micro-emulsion polymerization techniques where the resin is formed by polymerizing a monomer mixture that contains at least one polymerizable monomer in the presence of the magnetic material.

The present invention is additionally directed to a method of making the above-described containers whereby the above described sheet stock is molded or formed into the shape of one or more of the bottom tray and/or the cover of the above-described box.

The present invention further provides a method of deterring theft of an article which includes providing the above-described container containing the composite material, applying a magnetic field to an interrogation zone, causing movement of the container into the interrogation zone, and detecting a magnetic response resulting from the container moving into the interrogation zone.

### DESCRIPTION OF THE DRAWINGS

FIG. 1 is an exploded perspective view of a compact disc storage container according to the present invention.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, oligomers, homopolymers, copolymers and graft copolymers.

As used herein the term “thermoplastic” refers to polymeric and/or resinous materials and adjuvants and/or additives mixed therein that can be shaped by applying heat and/or pressure and that can repeatedly be softened by heating and hardened again on cooling.

Unless otherwise specified, all molecular weight values are determined using gel permeation chromatography (GPC) using appropriate polystyrene standards. Unless otherwise indicated, the molecular weight values indicated herein are weight average molecular weights (Mw).

As used herein the term “magnetic material” refers to materials, non-limiting examples being metals, that can be magnetized or attracted by a magnet and/or are able to produce a magnetic field external to itself and/or are able to produce a measurable magnetic change or signal when placed in a magnetic field.

As used herein the term “magnetic response” refers to the effect a magnetic material has on a magnetic field. As a non-limiting example, magnetic materials having a relative permeability of greater than one can amplify a magnetic field in a measurable way.

As used herein the term “magnetic properties” refers to the ability of a material to demonstrate the ability to be magnetized; be attracted by a magnet; to produce a magnetic field external to itself; to produce a magnetostrictive response, to produce a measurable magnetic change or signal when placed in a magnetic field; and/or to produce a magnetic response.

The present invention provides a composite material that includes a resin and a magnetic material. In an embodiment of the invention, the magnetic material is present as particles dispersed within the resin.

The resin contains a polymer obtained by polymerizing a monomer mixture that contains at least one polymerizable monomer. Any suitable polymerizable monomer can be used in the invention. As used herein, the term “polymerizable monomer” refers to a molecule containing a double bond that undergoes additional polymerization reactions when exposed to a free radical source. Non-limiting examples of polymerizable monomers include C₂-C₃₂ aliphatic or aromatic, linear, branched, or cyclic molecules containing an unconjugated double bond, C₂-C₃₂ aliphatic molecules containing two conjugated double bonds, C₁-C₃₂ aliphatic or aromatic, linear, branched, or cyclic esters of (meth)acrylic acid, vinyl esters of C₂-C₃₂ aliphatic or aromatic, linear, branched, or cyclic carboxylic acids, C₃-C₃₂ aliphatic molecules containing an allylic or methallylic group, (meth)-acrylonitrile, maleic anhydride, C₁-C₃₂ aliphatic or aromatic, linear, branched, or cyclic mono or di esters of maleic acid or itaconic acid, maleimide, and the like.

In an embodiment of the invention, the polymerizable monomer is selected from vinyl aromatic monomers; C₂ to C₂₂ linear or branched olefins; C₁ to C₂₂ linear, cyclic or branched esters of (meth)acrylic acid; maleic acid, its anhydride or mono- or di- C₁ to C₂₂ linear, cyclic or branched esters thereof; maleimide, itaconic acid, its anhydride or mono- or di- C₁ to C₂₂ linear, cyclic or branched esters thereof; fumaric acid or mono- or di- C₁ to C₂₂ linear, cyclic or branched esters thereof; C₄ to C₂₂ linear, branched, or cyclic conjugated dienes, (meth)acrylonitrile and combinations thereof.

In an embodiment of the invention, the vinyl aromatic monomers are selected from styrene, p-methyl styrene, α-methyl styrene, tertiary butyl styrene, dimethyl styrene, nuclear brominated or chlorinated derivatives thereof and combinations thereof.

In a particular embodiment of the invention, the monomer mixture includes styrene. Styrene can be present in the monomer mixture at a level of at least 25, in some cases at least 30 and in other cases at least 35 parts by weight based on the weight of the monomer mixture. Also, styrene can be present in the monomer mixture at a level of up to 100, in some instances up to 90, in other instance up to 80, in some cases up to 70, in other cases up to 65, in some instances up to 60, in other instances up to 55 and in particular situations up to 50 parts by weight based on the weight of the monomer mixture. The amount of styrene is determined based on the physical properties desired in the resulting composite material. The amount of styrene in the monomer mixture can be any value recited above or can range between any of the values recited above.

In an embodiment of the invention, the olefins in the monomer mixture include ethylene, propylene, 1-butene, isobutylene, 2-butene, diisobutylene, 1-pentene, 2-pentene, 1-hexene, 2-hexene, 1-octene, 2-octene, 3-octene, and combinations thereof. Upon polymerization, the repeat units derived from the olefins can be present in the form of homopolymers, copolymers, and/or block copolymers containing repeat units resulting from the polymerization of one or more of the olefins.

In an embodiment of the invention, the polymer can have a weight average molecular weight of at least 1,000, in some instances at least 5,000, in other instances about 10,000, in some situations at least 15,000, in other situations at least 25,000, in some cases at least 50,000 and in other cases not less than about 75,000, and can be up to 500,000, in some cases up to 400,000 and in other cases up to 300,000. The weight average molecular weight of the polymer can be any value or can range between any of the values recited above.

In another embodiment of the invention, the resin includes an elastomeric polymer. In a particular embodiment of the invention, the resin is characterized as having a continuous phase and a dispersed phase. The continuous phase contains the above-described polymer resulting from the polymerization of the monomer mixture and the dispersed phase contains at least a portion of the elastomeric polymer.

In a particular embodiment of the invention, the dispersed phase is present in the composite material at a level of at least 2 parts by weight, in some cases at least 3 parts by weight, in other cases at least 5 parts by weight, and in some situations at least 10 parts by weight based on the weight of the composite material. Also, the dispersed phase can be present in the composite material at a level of up to 50 parts by weight, in some cases up to 45 parts by weight, in other cases up to 40 parts by weight, in some instances up to 35 parts by weight, in other instances up to 30 parts by weight, and in particular situations up to 25 parts by weight based on the weight of the composite material. The amount of dispersed phase is determined based on the physical properties desired in the resulting composite material. The amount of dispersed phase in the composite material can be any value recited above or can range between any of the values recited above.

In an embodiment of the invention, the elastomeric polymer can have a weight average molecular weight of at least 1,000, in some instances at least 5,000, in other instances about 10,000, in some situations at least 15,000, in other situations at least 25,000, in some cases at least 50,000 and in other cases not less than about 75,000, and can be up to 500,000, in some cases up to 400,000 and in other cases up to 300,000. The weight average molecular weight of the elastomeric polymer can be any value or can range between any of the values recited above.

In an embodiment of the invention, the elastomeric polymer is selected from homopolymers of butadiene or isoprene; random, block, AB diblock, or ABA triblock copolymers of a conjugated diene with an aryl monomer and/or (meth)acrylonitrile; natural rubber; and combinations thereof. In a more specific embodiment, the elastomeric polymer can include one or more block copolymers selected from diblock and triblock copolymers of styrene-butadiene, styrene-butadiene-styrene, styrene-isoprene, styrene-isoprene-styrene, ethylene-vinyl acetate, partially hydrogenated styrene-isoprene-styrene, and combinations thereof.

In a further embodiment, the dispersed phase desirably contains one or more block copolymers, which can be rubbery block copolymers. Desirably, the block copolymers include one or more diblock and triblock copolymers of styrene-butadiene, styrene-butadiene-styrene, styrene-isoprene, styrene-isoprene-styrene and partially hydrogenated styrene-isoprene-styrene. Examples of suitable block copolymers include, but are not limited to, the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

In an embodiment of the invention, the block copolymer is a linear or radial block copolymer.

In an embodiment of the invention, the block copolymer has a weight average molecular weight of at least 50,000 and in some cases not less than about 75,000, and can be up to 500,000, in some cases up to 400,000 and in other cases up to 300,000. The weight average molecular weight of the block copolymer can be any value or can range between any of the values recited above.

In another embodiment of the invention, the block copolymer is a triblock styrene-butadiene-styrene or styrene-isoprene-styrene copolymer having a weight average molecular weight of from about 175,000 to about 275,000.

In a further embodiment of the invention, at least some of the polymers in the continuous phase are grafted onto the block copolymer in the dispersed phase.

In an embodiment of the invention, the dispersed phase is present as discrete particles dispersed within the continuous phase. Further to this embodiment, the volume average particle size of the dispersed phase in the continuous phase is at least about 0.1 μm, in some cases at least 0.2 μm and in other cases at least 0.25 μm. Also, the volume average particle size of the dispersed phase in the continuous phase can be up to about 2 μm, in some cases up to 1.5 μm and in other cases up to 1 μm. The particle size of the dispersed phase in the continuous phase can be any value recited above and can range between any of the values recited above.

In another embodiment of the invention, the aspect ratio of the discrete particles is from at least about 1, in some cases at least about 1.5 and in other cases at least about 2 and can be up to about 5, in some cases up to about 4 and in other cases up to about 3. When the aspect ratio of the dispersed particles is too large, the resulting thermoplastic sheet is hazy and not clear or transparent. The aspect ratio of the dispersed discrete particles can be any value or range between any of the values recited above. As a non-limiting example, the aspect ratio can be measured by scanning electron microscopy or light scattering.

The particle size and aspect ratio of the dispersed phase can be determined using low angle light scattering. As a non-limiting example, a Model LA-910 Laser Diffraction Particle Size Analyzer available from Horiba Ltd., Kyoto, Japan can be used. As a non-limiting example, a rubber-modified polystyrene sample can be dispersed in methyl ethyl ketone. The suspended rubber particles can then be placed in a glass cell and subjected to light scattering. The scattered light from the particles in the cell can be passed through a condenser lens and converted into electric signals by detectors located around the sample cell. As a non-limiting example, a He—Ne laser and/or a tungsten lamp can be used to supply light with a shorter wavelength. Particle size distribution can be calculated based on Mie scattering theory from the angular measurement of the scattered light.

The magnetic material, as described above, can be any material having the property of attracting iron and/or producing a magnetic field external to itself. In an embodiment of the invention, the magnetic material is present as particles dispersed within the resin.

In an embodiment of the invention, the magnetic material includes one or more compounds containing atoms or molecules selected from Ba, Fe, Ru, Co, Ni, Cd, Cr, Mo, Mn, W, V, Nb, Ta, Ce, Pr, Nd, Pm, Sm, Eu, Gd, Tb, Dy, Ho, Er, Tm, Yb, Lu, alloys thereof, and combinations thereof. Also, the magnetic material can optionally include silicon, nitrogen, sulfur, and/or oxygen atoms, non-limiting examples being oxides, nitrides, nitroxides, silicates, carbonates and/or sulfides of one or more of the above-mentioned magnetic materials. Further non-limiting examples of such materials include ferric oxide; ferrous oxide; barium ferrite; tert-butyl-aryl nitroxide, aryl-aryl nitroxide, nitronyl nitroxide, and/or imino nitroxide coordinated to Mn, Fe, and/or Ru; iron nitride; calcium iron silicate; calcium manganese iron silicate; iron sulfide; iron carbonate;

In an embodiment of the invention, the magnetic material can be a magnetite, macchiemite, goethite and/or ferrite according to the formula MOFe₂O₃, where M is selected from Mn, Co, Ni, Cu, Zn, Mg, Cd and combinations thereof.

In another embodiment of the invention, the magnetic material can include a complex of a paramagnetic organic ligand to multiple paramagnetic transition metal ions.

In a further embodiment of the invention, the magnetic material can be present in the resin as discrete particles dispersed within the polymer. Further to this embodiment, the volume average particle size of the magnetic material particles in the polymer can be at least about 0.001 μm, in some instances at least about 0.01 μm, in other instances at least about 0.1 μm, in some cases at least 0.2 μm and in other cases at least 0.25 μm. Also, the volume average particle size of the magnetic material particles dispersed in the polymer can be up to about 10 μm, in some cases up to 5 μm and in other cases up to 1 μm. The particle size of the magnetic material particles dispersed in the polymer can be any value recited above and can range between any of the values recited above.

In another embodiment of the invention, the aspect ratio of the magnetic material particles can be from at least about 1, in some cases at least about 1.5 and in other cases at least about 2 and can be up to about 5, in some cases up to about 4 and in other cases up to about 3. When the aspect ratio of the magnetic material particles is too large, the resulting thermoplastic sheet can be hazy and not clear or transparent. The aspect ratio of the magnetic material particles can be any value or range between any of the values recited above. As a non-limiting example, the particle size and/or aspect ratio can be measured by scanning electron microscopy or light scattering.

In an embodiment of the invention, the magnetic material can be present in the composite material at a level of at least about 0.001, in some cases at least 0.01, in other cases at least 0.1, in some situations at least 1, and in other situations at least 2 weight percent of the composite material. Also, the magnetic material can be present at a level of up to about 25, in some cases up to 20, in other cases up to 15, and in some instances up to 10 weight percent of the composite material. The amount of magnetic material present in the composite material will be an amount sufficient to provide desirable magnetic properties as described herein, but not so much as to cause the physical properties of the composite material to not meet the intended use of the material. The amount of magnetic material in the composite material can be any value or can range between any of the values recited above.

In an embodiment of the invention, the magnetic material is present at a level sufficient to allow the composite material to be detected when it enters a magnetic field or interrogation zone as described below by providing a measurable magnetic response.

In a further embodiment of the invention, the type and amount of magnetic material is selected to provide a desired coercivity to the composite material. The desired coercivity is determined based on the planned use of the composite material. As used herein, the term “coercivity” refers to a measure of how difficult it is to encode information on the composite material, typically measured in Oersteds (Oe) and can be determined according to ISO/IEC 7811. The coercivity of the composite material can be at least 50, in some cases at least 100, and in other cases at least 200 Oe. Also, the coercivity of the composite material can be up to 4,000, in some cases up to 3,500 and in other cases up to 3,000 Oe. The coercivity of the composite material can be any value or range between any of the values recited above.

In embodiments of the invention, the composite material can be a low coercivity material. As such, the coercivity of the magnetic material is less than 1,000, in some cases less than 900, and in other cases less than 750 Oe.

In embodiments of the invention, the composite material can be a high coercivity material. As such, the coecivity of the magnetic material is greater than 1,000, in some cases at least 1,500, and in other cases at least 2,000 Oe.

In a particular embodiment of the invention, the composite material includes at least one styrene-based polymer (homopolymer or copolymer) and the magnetic material includes a silicon, a cobalt, a nickel, and/or an iron-containing alloy.

The resin described above can be formed by forming a monomer mixture as described above, in which one or more elastomeric polymers can be dissolved and/or dispersed, deaerating or sparging with nitrogen, while mixing and adding a suitable free radical polymerization initiator at a suitable temperature to effect free radical polymerization, optionally in the presence of the magnetic material. In an embodiment of the invention, when an elastomeric polymer is included, at least some of the monomer mixture reacts with unsaturated groups in the elastomeric polymer to provide grafting to the elastomeric polymer. Methods for polymerizing the monomer mixture and dispersed phase are known in the art. Examples of such methods are disclosed in, as non-limiting examples, U.S. Pat. No. 4,772,667 to Biletch et al., and No. 5,891,962 to Otsuzuki et al., the relevant portions of which are herein incorporated by reference. Desirably, the manufacturing conditions are adapted to provide thermoplastic compositions, thermoplastic sheets and thermoplastic items having the properties described herein.

The composite material can be prepared as described above using bulk, suspension, emulsion, mini-emulsion or micro-emulsion polymerization techniques as are known in the art.

Any suitable polymerization initiator can be used in the invention. Non-limiting examples of suitable polymerization initiators include dibenzoyl peroxide, di-tert-butyl peroxide, dilauryl peroxide, dicumyl peroxide, didecanoyl peroxide, tert-butyl peroxy-2-ethylhexanoate, tert-butyl perpivalate, tert-butyl peroxyacetate, or butyl peroxybenzoate and also azo compounds, e.g., 2,2′-azobis(2,4-dimethylvaleronitrile), 2,2-azobis-(isobutyronitrile),2,2′-azobis(2,3-dimethylbutyronitrile) 1,1′-azobis-(1-cyclohexanenitrile), as well as combinations of any of the above.

In an embodiment of the invention, adjuvants, such as pigments or colorants or both can be included in the resin. As non-limiting examples, the pigments and/or colorants can include titanium dioxide. The pigments and/or colorants when added to the resin will generally result in an opaque sheet. A clear or transparent sheet can be defined as having Haze values of 10% or less, and it is known to those skilled in the art that Haze values generally do not apply to an opaque sheet.

As used herein, “pigments and/or colorants” refer to any suitable inorganic or organic pigment or organic dyestuff. Suitable pigments and/or colorants are those that do not adversely impact the desirable physical properties of the thermoplastic sheet. The pigments and/or colorants can include magnetic materials. Non-limiting examples of inorganic pigments include titanium dioxide, iron oxide, zinc chromate, cadmium sulfides, chromium oxides and sodium aluminum silicate complexes. Non-limiting examples of organic type pigments include azo and diazo pigments, carbon black, phthalocyanines, quinacridone pigments, perylene pigments, isoindolinone, anthraquinones, thioindigo and solvent dyes.

In another embodiment of the invention, the adjuvants can include one or more additives selected from lubricants, fillers, light stabilizers, heat stabilizers, surface-active agents, and combinations thereof. These additives, when added to the thermoplastic composition will generally result in an opaque sheet.

Suitable fillers are those that do not adversely impact, and in some cases enhance, the desirable physical properties of the thermoplastic sheet. Suitable fillers include, but are not limited to, calcium carbonate in ground and precipitated form, barium sulfate, talc, glass, clays such as kaolin and montmorillonites, mica, and combinations thereof.

Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, and/or combinations thereof.

Generally, any conventional ultra-violet light (UV) stabilizer known in the art can be utilized in the present invention. Non-limiting examples of suitable UV stabilizers include 2-hydroxy-4-(octyloxy)-benzophenone, 2-hydroxy-4-(octyl oxy)-phenyl phenyl-methanone, 2-(2′-hydroxy-3,5′-di-teramylphenyl) benzotriazole, and the family of UV stabilizers available under the trademark TINUVIN® from Ciba Specialty Chemicals Co., Tarrytown, N.Y.

Heat stabilizers that can be used in the invention include, but are not limited to, hindered phenols, non-limiting examples being the IRGANOX® stabilizers and antioxidants available from Ciba Specialty Chemicals.

When any or all of the indicated adjuvants are used in the present invention, they can be used at a level of at least 0.01 weight percent, in some cases at least 0.1 weight percent and in other cases at least 0.5 and up to 10 weight percent, in some cases up to 7.5 weight percent, in other cases up to 5 weight percent, and in some situations up to 2.5 weight percent of the composite material. The amount, type and combination of adjuvants used will depend on the particular properties desired in the composite material. The amount of any single adjuvant or any combination of adjuvants can be any value recited above and can range between any of the values recited above.

Thorough mixing and dispersion of the additive in the resin is important, but otherwise processing conditions are similar to those typically employed in the art.

In embodiments of the invention, the magnetic material is incorporated in the composite material as micron-sized and/or nano-sized powders. As such, the magnetic material can have a particle size of at least 10⁻⁶ mm, in some cases at least 10⁻⁵ mm, in other cases at least 10⁻⁴ mm and in some instances at least 10⁻³ mm. Also, the magnetic material can have a particle size of up to 1 mm, in some cases up to 0.1 mm, and in other cases up to 0.01 mm. The particle size of the magnetic particle can be any value recited above or can range between any of the values recited above.

In an embodiment of the invention, surface-modifying additives can be included in the composite material and/or magnetic material. The surface modified particles can be prepared by
forming an aqueous dispersion of particles comprising the magnetic material, and one or more surface active agents;
subjecting the dispersion to high shear mixing conditions; and
combining the dispersion with an aqueous solution comprising a surface modifying agent.

In an embodiment of the invention, the surface modifying agent can include polyvinylalcohol, natural waxes, polyolefin waxes, white oil and combinations thereof.

More particularly, the waxes used in the present invention, at atmospheric pressure, are typically solid at 20° C. and below, in some cases 25° C. and below, and in other cases 30° C. and below, and are liquid at 125° C. and above, in some cases 150° C. and above, and in other cases 200° C. and above. The physical properties of the waxes used in the present invention are selected to provide the desirable properties in the present composition as described herein.

In an embodiment of the invention, the waxes are selected from natural and/or synthetic waxes. As such, the waxes used in the present invention can be one or more materials selected from C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl alcohols, C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl carboxylic acids and/or their corresponding ammonium and metal salts and C₁ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl esters, C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl hydrocarbons, polyethylene, polypropylene, polyester, and combinations thereof, so long as they meet a combination of liquid and solid temperatures as defined above.

The white oils used in the present composition are typically liquid at atmospheric pressure and 20° C. and above, in some cases 15° C. and above, in other cases 10° C. and above, in some instance 5° C. and above and in other instance 0° C. and above. As such, the white oils used in the present invention can be one or more materials selected from C₁₀ to C₃₂, in some cases C₁₂ to C₂₄, and in other cases C₁₂ to C₂₂ linear, branched or cyclic alkyl hydrocarbons, so long as the physical properties described above are present.

In another embodiment of the invention, the surface modifying agent can be present in the aqueous solution at a level of at least about 0.01, in some situations at least about 0.05, in some cases at least 0.1, in other cases at least 0.25, in some instances at least 0.5 and in other instances at least 1 wt. %. Also, the surface modifying agent can be present in the aqueous solution at a level of up to about 10, in some cases up to 7.5, and in other cases up to 5 wt. % based on the weight of the aqueous solution.

In an embodiment of the invention, the resin is formed by polymerizing a monomer mix, as described above, in the presence of the magnetic material, to form the composite material. In this embodiment, the magnetic material is added to the monomer mixture, which is then polymerized as described above.

In a particular embodiment of the invention, the composite material is prepared by a suspension polymerization method that includes:
surface modifying particles that include the magnetic material to provide surface modified particles;
combining the surface modified particles with a monomer composition that includes styrene and optionally other monomers as described above, and a polymerization initiator to provide a polymerization mixture;
polymerizing the polymerization mixture to provide a suspension of composite beads; and
recovering the composite beads.

In a particular embodiment of the invention, the polymerization can be carried out using the methods described in U.S. Application Publication No. 2006-0276558 A1, the relevant portions of which are herein incorporated by reference, where a dispersion of droplets containing the monomer phase are formed by pressure atomizing an the monomer phases to form a dispersion of organic droplets. The magnetic material can optionally be included in the monomer phase.

In another embodiment of the invention, the composite material is prepared by mechanically milling the magnetic material into the already formed resin.

In an embodiment of the invention, the mechanical milling can include melt compounding.

In another embodiment of the invention, the mechanical milling can include milling using equipment selected from batch mixers, single-screw extruders, twin- screw extruders and combinations thereof.

In a further embodiment of the invention, the mechanical milling can include ball milling using a weight ratio of balls to composite material of from at least 2:1, in some cases at least 3:1 and in other cases at least 5:1 and can be up to 25:1, in some cases up to 20:1, in other cases up to 15:1, and in some situations up to 10:1. The weight ratio of stainless steel balls to composite material can be any value or range between any of the values recited above.

The media balls can be composed of any suitable materials. Suitable media ball materials include, but are not limited to steel, stainless steel, iron, lead, antimony, brass, copper, nickel, porcelain, ceramic, pebble, chromium, and combinations and alloys thereof.

The media balls can be at least 0.1, in some cases at least 1 and in other cases at lest 2 mm in diameter and can be up to 150, in some instances up to 100, in other instances up to 50, in some situations up to 40, in other situations up to 30, in some cases up to 25, and in other cases up to 20 mm in diameter. The media balls used in the ball mills can be any size or range between any of the sizes indicated above.

In an embodiment of the invention, the composite material can be formed into a thermoplastic sheet.

The present thermoplastic sheet can be prepared by working the above-described composite material to form the thermoplastic sheet. Desirably, the composite material, along with any desired adjuvants and/or other polymers are combined, may be mixed on a heated mill roll or other compounding equipment, and the mixture cooled, granulated and extruded into a sheet. The formulation can be admixed in extruders, such as single-screw or double-screw extruders, compounded and extruded into pellets, which can then be re-fabricated. The extruder can also be used to extrude the composite material as pipe, sheet, film or profile.

The composite material can be extruded at a temperature that allows for formation of a sheet with the desired physical properties. In an embodiment of the invention, the composite material is extruded at from at least about 250° F. (121° C.), in some instances at least about 300° F. (149° C.), in other instances at least about 400° F. (204° C.), in some cases at least about 450° F. (232° C.) and up to about 500° F. (288° C.), in some cases up to about 550° F. (260° C.) in some instances up to about 600° F. (316° C.), and in other instances up to about 650° F. (326° C.). The extrusion temperature will depend on the composition of the materials used and on the physical properties desired in the resulting sheet. The extrusion temperature can be any temperature or range between any of the temperatures indicated above.

Films or sheets may be uniaxially or biaxially oriented either during extrusion or after such processing by reheating and stretching.

Films or sheets may be treated with additives after forming, such as appropriate heat-seal adhesives, coatings for ink adhesions, printing, labels, and the like.

In an embodiment of the invention, the thermoplastic sheet can have a thickness of at least about 0.05 mm, in some cases at least about 0.1 mm and in other cases at least about 0.25 mm and can be up to about 5 mm, in some cases up to about 4 mm, in other cases up to about 5 mm, in some instances up to about 7.5 mm and in other instances up to about 10 mm. The thickness of the thermoplastic sheet can vary depending on its intended use. The thickness of the thermoplastic sheet can be any value or can range between any of the values recited above.

Once formed, printing can be applied to the present thermoplastic sheet. Typically, a printed layer is applied over at least a portion of a surface of the thermoplastic sheet. The printed layer can be applied using art known methods, not limited to, offset printing, gravure printing, stamping, and the like.

In an embodiment of the invention, the surface of the sheet can be treated prior to printing. Any suitable surface treatment that improves the quality of the printing and/or improves the printability of the sheet surface can be used. As a non-limiting example, the surface treatment can be an oxidative surface treatment, a non-limiting example being corona discharge, which can be used to improve ink receptivity prior to printing. As a non-limiting example, the corona treatment can be applied using one of the UNI-DYNE® corona systems available from Corotec Corporation, Farmington, Conn.

Desirably, the printed layer includes an ink composition. Any suitable ink composition known in the art can be used, so long as the ink composition is substantive to the thermoplastic sheet.

The invention also provides thermoformed articles made from the thermoplastic sheet. Non-limiting examples of such articles include packages, such as jewel boxes for CDs and DVDs, as well as any package where it can be advantageous to incorporate a magnetic material into the package, as for example to deter theft. As such, packages or containers for jewelry, watches, electronics, computers, stereo equipment, video equipment and the like can be made from the present composite material and thermoplastic sheets of the composite material.

Further, thermoplastic sheets of the present composite material can be used in a multi-layer thermoplastic composite that includes one or more substrate layers and one or more layers made from the composite material of the invention and one or more layers containing another thermoplastic material, which multi-layer composites can be thermoformed into articles as described above.

In an embodiment of the invention, another thermoplastic material can be selected from impact modified polystyrene, copolymers comprising styrene and maleic anhydride and optionally an alkyl (meth)acrylate, rubber modified copolymers comprising styrene and maleic anhydride and optionally an alkyl (meth)acrylate, polyolefins, poly(meth)acrylates, and combinations thereof.

In an embodiment of the invention, the composite material can be formed into one or more parts of a storage container. As such, the present invention provides a storage container that includes a box including a bottom tray and a cover, the cover being movable between alternative open and closed positions relative to the bottom tray, where at least a portion of at least one of the bottom tray and/or the cover includes the composite material described above.

More specifically, once the desired temperature is reached, the thermoplastic sheet can be formed into the desired shape by known processes such as plug assisted thermoforming where a plug pushes the thermoplastic sheet into a mold of the desired shape. Air pressure and/or vacuum can also be employed to mold the desired shape.

In a particular embodiment of the invention, a label can be placed in the thermoforming machine prior to forming the container and adheres to the formed container.

In a further embodiment of the invention, the storage container can be made using injection molding techniques that are known in the art.

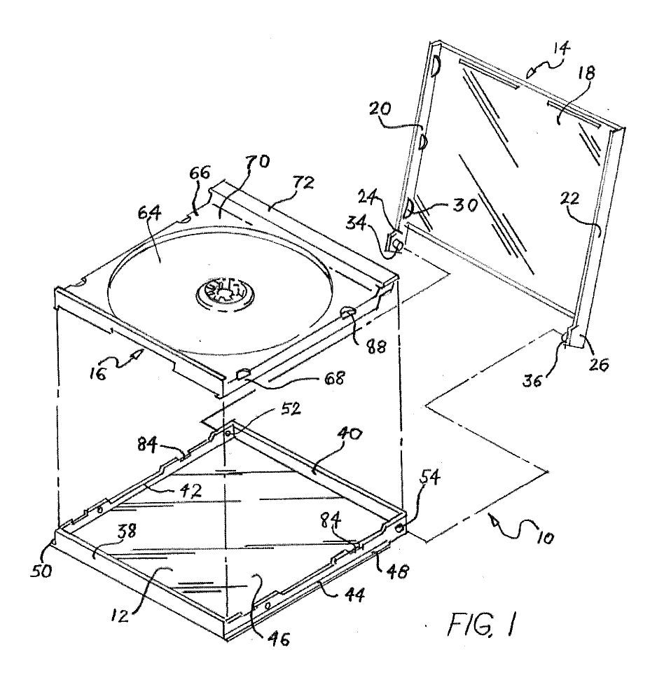

FIG. 1 shows a non-limiting example of a container embodiment of the present invention generally at 10, with the components illustrated in an exploded perspective relationship. It is seen that the container includes a bottom tray 12, a cover or lid 14, and an insert tray shown generally at 16 to be inserted into the bottom tray 12. The lid 14 includes a top plate 18, a pair of sidewalls 20 and 22, ears 24 and 26 attached to the rear ends of the sidewalls, spaced tabs 30 extending inwardly from the sidewalls beneath the top plate, and pegs 34 and 36 extending inwardly from the ears. The bottom tray 12 similarly includes front and rear walls 38 and 40, sidewalls 42 and 44 extending between them and a bottom floor 46. The floor 46 extends a very short distance beyond the sidewalls 42 and 44 to form lips 48 and 50, which the sidewalls 20 and 22 of the cover 14 abut down against when the cover is in a closed position. A pair of holes, 52 and 54, pass through the sidewalls 42 and 44 at the rear corners thereof for receiving therein the pegs 34 and 36 of the cover 14 to provide a pivotal axis for movement of the cover relative to the bottom tray 12.

The insert tray 16 includes a top plate having a central circular recessed area 64 configured for storing therein a compact disc. The recessed area 64 can engage the insert sidewalls at central portions thereof so that a disc when in the recessed area overhangs, by only a fractional distance, the central portions of the sidewalls. The disc then fits into the corresponding lower portions of the sidewalls of the bottom tray 12. The insert tray 16 has sidewalls 66 and 68 particularly at the corners thereof, that is, where the recessed area 64 does not engage the edges of the top plate 12. At the rear edge of the insert tray 16 is a step 70 with an elongated tab or member 72 formed on top of it. With the container 10 assembled, the pivoting of the pegs 34 and 36 on the cover 14 relative to the holes 52 and 54 of the bottom tray 14 then takes place beneath the elongated member 72. When the cover 14 is pivoted to a closed position, the elongated member 72 forms part of the top surface of the container 10 with the forward edge of the elongated member abutting the rear edge of the top plate 18 of the cover.

The bottom tray 12 has a pair of indents 84 on both sides of the sidewalls, and the insert tray 16 has corresponding semi-circular recessed areas 88 along both of its side edges 66 and 68 and corresponding to the indents 84. Thus, when the lid 14 is lowered to its closed position, the tabs 30 on the lid will rest downwardly in the indents 84 and the semi-circular recessed areas 88 and thereby hold the insert tray 16 down against the floor 46 of the bottom tray 12. Thus, when the case or container 10 is inverted or shaken back and forth, the insert tray 16 and compact disc (not shown) do not likewise rattle back and forth thereby impacting the lid 14. The primary function of tabs 30 though is to hold graphics, that is, a sheet of paper (not shown) with explanatory or advertising information on it, in place in the container and viewable through the top cover, which can be transparent. The insert tray 16 can have a number of tiny outwardly-disposed pegs on the sidewalls thereof positioned to snap into corresponding inwardly-disposed holes or openings in the sidewalls of the bottom tray 12 to snap-fit hold the insert tray 16.

In an embodiment of the present invention, any of bottom tray 12, or cover or lid 14, or insert 16, or all or a potion thereof can include a thermoplastic, such as any of the above described resins and/or polymers not containing the magnetic material. The present composite material can then be applied to at least a portion of at least one surface of bottom tray 12, or cover or lid 14, or insert 16, using laminating techniques, injection molding techniques, or the like as are known in the art. In a particular embodiment of the invention, the magnetic material is applied to a surface of the bottom tray 12, or cover or lid 14, or insert 16 as a logo or other indicia.

According to one aspect of the present invention articles that include the present composite materials and/or articles that are made from thermoplastic sheets of the present composite material can be used to provide a magnetic marker or tag or magnetic element, which in some embodiments of the invention can be characterized as carrying a plurality of discrete magnetically active regions in a linear array. As such, the magnetic elements are incorporated directly into the articles during manufacture of the articles themselves. Thus, the articles can be used in conjunction with articles or goods, such as retail goods, which carry the tags for inventory or security purposes, as tickets or security passes.

In relatively simple embodiments of the invention, each magnetically active region of an article can have the same magnetic characteristics; in more complex embodiments, each magnetically active region of an article can possess a different magnetic characteristic, thus making it possible to assemble a large number of tags, each with unique magnetic properties and hence with a unique magnetic identity and signature (i.e., magnetic response when processed by a suitable reader device).

In an embodiment of the invention, the article can contain portions that include a magnetically soft material (low coercivity), which produces a characteristic signal when excited by an alternating magnetic field, and portions that include a magnetically semi-hard or hard material (high coercivity).

In embodiments of the invention, an anti-theft system can include a signal generator made of a ferromagnetic material with a relatively low coercivity and high permeability for easy magnetic detection. The signal generated can be dependent on the magnetic field and can be detected in the interrogation zone. Also present in the element is a deactivator that includes at least one section containing a ferromagnetic material with a high coercivity connected to the signal generator, which suppress the generation of detectable signals when magnetized. The sections include at least one (often finely distributed) ferromagnetic material and a polymeric support.

In an embodiment of the invention, one of the tray or cover of the storage container can include a composite material having a low coercivity and high permeability and the other of the tray or cover contains a composite material that is a material having high coercivity.

In another embodiment of the invention, a surface of the tray or cover of the storage container has disposed thereon a composite material having a low coercivity and high permeability and an oppositely disposed surface of the tray or cover contains a composite material having a high coercivity material. The composite material can be applied to the surfaces by laminating or by injection molding or as a logo or indicia applied to the surface.

In an embodiment of the invention, because the invention can utilize relative movement between a tag and an applied magnetic field, it will be appreciated that there will be a correspondence between the time domain of output signals from a tag reading device and the linear dimensions of the magnetically active regions of a tag and of the gaps between the magnetically active regions. In this sense, the active regions and the gaps between them function analogously to the elements of an optical bar code (black bar or white gap between adjacent bars). It follows from this that, just as variability of magnetic characteristics in the active regions can be used to generate part of a tag “identity”, so can the linear spacing between adjacent magnetically active regions, as for example in a laminated sandwich structure of the present composite material. It will readily be understood that a vast number of tags, each with its own unique identity, can thus be produced in accordance with this invention.

As well as the tags defined above, the present invention provides a variety of useful methods for detecting the presence of a magnetic marker and/or for identifying such a marker.

An embodiment of the invention provides a method of interrogating a magnetic tag or marker within a predetermined interrogation zone, the tag includes a high permeability magnetic material, for example, to use the response of the tag to detect its presence and/or to determine its position within the interrogation zone. The interrogation process can include the step of subjecting the tag sequentially to: (1) a magnetic field sufficient in field strength to saturate the high permeability magnetic material, and (2) a magnetic null as defined herein.

In an embodiment of the invention, the magnetic null is caused to sweep back and forth over a predetermined region within the interrogation zone. The scanning frequency (i.e., the sweep frequency of the magnetic null) can be relatively low, e.g., 1-500 Hz. Conveniently, the field pattern is arranged so that (a) the magnetic null lies in a plane; and (b) the saturating field occurs adjacent of the plane.

Another embodiment of the invention provides a method of determining the presence and/or the position of a magnetic element within a predetermined interrogation zone, the magnetic element having predetermined magnetic characteristics. The method can include the steps of: (1) establishing within the interrogation zone a magnetic field pattern which includes a relatively small region of zero magnetic field (a magnetic null) contiguous with regions where there is a magnetic field sufficient to saturate the, or a part of the, magnetic element (the saturating field), the relatively small region being coincident with a region through which the magnetic element is passing, or can pass, or is expected to pass; (2) causing relative movement between the magnetic field and the magnetic element such that the magnetic null is caused to traverse at least a part of the magnetic element in a predetermined manner; and (3) detecting the resultant magnetic response of the magnetic element during the relative movement.

A further embodiment of the invention provides a method of identifying a magnetic element, which possesses predetermined magnetic characteristics. The method includes the steps of: (1) subjecting the magnetic element to a first magnetic field which is sufficient to induce magnetic saturation in at least a part of the magnetic element; (2) next subjecting the magnetic element to conditions of zero magnetic field (i.e., a magnetic null), the zero field occupying a relatively small volume and being contiguous with said first magnetic field; (3) causing relative movement between the applied magnetic field and the magnetic element such that the magnetic null is caused to traverse at least a part of the magnetic element in a predetermined manner; and (4) detecting the resultant magnetic response of the magnetic element during the relative movement.

In the identification method defined above, the magnetic element is advantageously caused to traverse an interrogation zone within which the required magnetic conditions are generated.

The relative movement between the magnetic element and the magnetic field can advantageously be produced by sweeping the applied magnetic field over the magnetic element. Alternatively, the relative movement can be achieved by the application of an alternating magnetic field to a generally static magnetic field pattern.

The material field or field pattern utilized in the methods defined above can be established by the means of two magnetic fields of opposite polarity. This can conveniently be achieved by use of one or more coils carrying direct current; or by the use of one or more permanent magnets; or by a combination of coil(s) and magnet(s).

Where a coil is used, it may be arranged to carry a substantially constant current so as to maintain the magnetic null at a fixed point. Alternatively, the coil(s) carry/carries a current whose magnitude varies in a predetermined cycle so that the position of the magnetic null is caused to oscillate in a predetermined manner termed a “flying null”. A similar arrangement can be used to give a flying null when both a coil or coils and a permanent magnet are used.

According to a further aspect of the present invention, there is provided a method of determining the presence and/or the position of a magnetic element, which is characterized by the steps of: (1) applying a magnetic field to a region where the magnetic element is, or is expected to be, located, the magnetic field including two opposed field components, generated by magnetic field sources, which result in a null field (a magnetic null) at a position intermediate to the magnetic field sources (which position is known or can be calculated); (2) causing relative movement between the magnetic field and the magnetic element; and (3) detecting the resultant magnetic response of the magnetic element during the relative movement.

Relative movement between the magnetic field and the magnetic element can be achieved by applying a relatively low amplitude alternating magnetic field superimposed on the DC field. Typically, such a low amplitude alternating magnetic field has a frequency in the range from 10 Hz to 100 kHz, in some cases from 50 Hz to 50 kHz, and in other cases from 500 Hz to 5 kHz.

In one embodiment, the coils carry a substantially constant current so as to maintain the magnetic null at a fixed point. In another embodiment, the coils carry a current whose amplitude varies in a predetermined cycle so that the position of the magnetic null is caused to oscillate in a predetermined manner.

In the methods according to the invention, detection of the magnetic response of the magnetic element advantageously includes observation of harmonics of the applied AC field, which are generated by the magnetic element as its magnetization state is altered by passing through the magnetic null.

As indicated above, the system can operate with a zero or very low frequency scanning field, and an HF (high frequency) in the range 50 Hz-50 kHz. This allows for good signal penetration through most materials including thin metal foils. In addition, international regulations allow high fields for transmission at these low frequencies.

Embodiments of the invention provide a multi-bit data tag system, which employs low-frequency inductive magnetic interrogation, and avoids the need for complex, expensive tags.

According to another aspect of the present invention, there is provided a method of coding and/or labeling individual articles within a predetermined set of articles by means of data characteristic of the articles, e.g., article price and/or the nature of the goods constituting the articles. The method includes making articles from the present composite material where the articles have a magnetic tag or marker carrying a predetermined arrangement of magnetic zones unique to that article or to that article and others sharing the same characteristic, e.g., article price or the nature of the goods constituting the article (the unique magnetic tag can be the result of the type and/or concentration of the magnetic material in the composite material), the magnetic tag or marker being susceptible to interrogation by an applied magnetic field to generate a response indicative of the magnetic properties of the tag or marker and hence indicative of the nature of the article carrying the magnetic tag or marker.

The present invention will further be described by reference to the following examples. The following examples are merely illustrative of the invention and are not intended to be limiting. Unless otherwise indicated, all percentages are by weight.

### EXAMPLES

### Example 1

This example describes using mechanical milling to make highly dispersed and concentrated polymer magnetic composites according to the invention. 0.48 g of ground Polystyrene-1220 (NOVA Chemicals Inc., Pittsburgh, Pa.) and 0.0560 g of micron-sized Fe₃O₄ (Sigma-Aldrich, St. Louis, Mo.) was added to a stainless steel crucible containing 7 stainless steel balls, adding 7.3705 g in weight. The polystyrene and magnetic component ingredients were intimately mixed by ball milling for 8 hours. The milling operation was stopped every 15 minutes for 15 minutes and then re-started to avoid overheating the sample, as generally described in Mat. Sci. Eng. B, 113, 228-235 (2004). A polyvinyl alcohol surface modifying additive (0.1 wt. % of powder) was added to aid dispersion. An extruded sheet was formed from the resulting powder. The sheet demonstrated magnetic properties.

### Example 2

This example describes using mechanical milling to make highly dispersed and concentrated polymer magnetic composites according to the invention. 0.48 g of ground Polystyrene-1220 and 0.057 g of nano-sized Fe₃O₄ (Sigma-Aldrich, St. Louis, Mo.) was added to a stainless steel crucible containing 7 stainless steel balls, adding 7.3705 g in weight. The polystyrene and magnetic components were intimately mixed by ball milling for 8 hours. The milling operation was stopped every 15minutes for 15 minutes and then re-started to avoid overheating the sample as generally described in Mat. Sci. Eng. B, 113, 228-235 (2004). A polyvinyl alcohol surface modifying additive (0.1 wt. % of powder) was added to aid dispersion. An extruded sheet was formed from the resulting powder. The sheet demonstrated magnetic properties.

### Example 3

This example describes using melt compounding to make highly dispersed and concentrated polymer magnetic composites according to the invention. Melt compounding was done in a 40 g capacity Brabender single screw type six mixer. The ratio of ground polymer to magnetic powder (micron-sized or nano-sized) was 9:1. In a first sample, 36 g of Polystyrene-1220 was melt blended with 4 g of micron-sized Fe₃O₄. In a second sample, 36 g of Polystyrene-1220 was melt blended with 4 g of micron- sized NiFe₂O₄ (Sigma-Aldrich). In a third sample, 36 g of Polystyrene-1220 was melt blended with 4 g of nano-sized Fe₃O₄. In a fourth sample, 36 g of Polystyrene-1220 was melt blended with 4 g of nano-sized or NiFe₂O₄ (Sigma-Aldrich). In a fifth sample, 32 g of Polystyrene-1220 was melt blended with 4 g of micron-sized Fe₃O₄ and 4 g of Joncryl® ADR3205 (Johnson Polymers, The Slough, Studley, Warwickshire, United Kingdom) as a compatibilizing agent. Additional samples were prepared as in the fifth sample using sodium dodecyl benzene sulfonate; SMA® EF80, SMA IOOOF, and SMA 3000F SMA styrene maleic anhydride copolymers available from the Sartomer Company, Inc., Exton, Pa.; Joncryl ADR3300, Joncryl ADR4300, Joncryl ADR4315 (Johnson Polymers) and Ricon® 130MA8 (Sartomer) as compatibilizing agents. Aside from Ricon 130MA8, which was processed at 180° C., all blends were prepared at 200° C. for 10 minutes at 100 rpm. Composite magnetic blends were quenched using liquid nitrogen.

Sheets made from the samples in this example all had good mechanical integrity and demonstrated magnetic properties.

### Example 4

This example describes a synthetic approach to manufacture magnetic composites according to the invention using suspension polymerization techniques.

Sample a) an aqueous dispersion of magnetic particles (nano-sized Fe₃0₄ (Sigma-Aldrich), 100 mg in 15 ml water) and sodium dodecyl benzene sulfonate (100 mg in 15 ml water) were sonicated for 15 minutes and exposed to high shear mixing for another 15 minutes. The magnetic and surface modifier solutions were mixed and sonicated another 15 minutes. The mixture of magnetic particle/surface modifier aqueous solutions was added to a 2 wt. % aqueous solution of polyvinylalcohol. Styrene monomer, 25 g, and 0.16 g of benzoyl peroxide initiator were added to the mixture. The system was closed, purged using nitrogen and stirred at 250 rpm. The temperature was raised to 95° C. and polymerization was carried out for 6 hours. The resulting polymer beads were recovered by filtering and successive washes using water and methanol. The beads were extruded to form a sheet, which demonstrated magnetic properties.

Sample b) an aqueous dispersion of magnetic particles (nano-sized NiFe₂O₄ (Sigma-Aldrich), 330 mg in 50 ml water) and sodium dodecyl benzene sulfonate (330 mg in 50 ml water) were sonicated for 15 minutes and exposed to high shear mixing for another 15 minutes. The magnetic and surface modifier solutions were mixed and sonicated another 15 minutes. The mixture of magnetic particle/surface modifier aqueous solutions was added to a 1 wt. % aqueous solution of polyvinylalcohol. Styrene monomer, 200 g, and 1.25 g of benzoyl peroxide initiator were added to the mixture. The system was closed, purged using nitrogen and stirred at 250 rpm. The temperature was raised to 93° C. and polymerization was carried out for 6 hours at 350 rpm. The resulting polymer beads were recovered by filtering and successive washes using water and methanol. The beads were extruded to form a sheet, which demonstrated magnetic properties.

Sample c) an aqueous dispersion of magnetic particles (nano-sized NiFe₂O₄ (Sigma-Aldrich), 330 mg in 50 ml water) and sodium dodecyl benzene sulfonate (330 mg in 50 ml water) were sonicated for 15 minutes and exposed to high shear mixing for another 15 minutes. The magnetic and surface modifier solutions were mixed and sonicated another 15 minutes. The mixture of magnetic particle/surface modifier aqueous solutions was added to a 0.1 wt. % aqueous solution of polyvinylalcohol. Styrene monomer, 180 g, containing 20 g of dissolved Polytysrene-1220 and 1.125 g of benzoyl peroxide initiator were added to the mixture. The system was closed, purged using nitrogen and stirred at 250 rpm. The temperature was raised to 93° C. and polymerization was carried out for 6 hours at 350 rpm. The resulting polymer beads were recovered by filtering and successive washes using water and methanol. The beads were extruded to form a sheet, which demonstrated magnetic properties.

Sample d) an aqueous dispersion of magnetic particles (nano-sized NiFe₂O₄ (Sigma-Aldrich), 30 mg in 5 ml water) and sodium dodecyl benzene sulfonate (30 mg in 5 ml water) were sonicated for 15 minutes and exposed to high shear mixing for another 15 minutes. The magnetic and surface modifier solutions were mixed and sonicated another 15 minutes. The mixture of magnetic particle/surface modifier aqueous solutions was added to a 3 wt. % aqueous solution of polyvinylalcohol and 0.4 wt. % polydiallyldimethyl ammonium chloride (low molecular weight, Sigma-Aldrich). Styrene monomer, 22.5 g, with 2.5 g of dissolved polybutadiene rubber (Diene 55AC10, Firestone Polymers) and 0.1560 g of benzoyl peroxide initiator were added to the mixture. The system was closed, purged using nitrogen and stirred at 250 rpm. The temperature was raised to 94° C. and polymerization was carried out for 6 hours at 350 rpm. The resulting polymer beads were recovered by filtering and successive washes using water and methanol. The beads were extruded to form a sheet, which demonstrated magnetic properties.

### Example 5

This example describes using mechanical milling to make highly dispersed and concentrated polymer magnetic composites according to the invention. About a 9:1 ratio of ground polymer (ZYLAR®-EX, styrene methyl methacrylate copolymer available from NOVA Chemicals Inc., Pittsburgh, Pa.) to magnetic powder (iron oxide powder) is added to a stainless steel crucible containing stainless steel balls. The weight ratio of stainless steel balls to powder (polymer and magnetic) is about 14:1. Ball milling is conducted for 8 hours, and is stopped every 15 minutes for 15 minutes and then re-started to avoid overheating the sample as generally described in Mat. Sci. Eng. B, 113, 228-235 (2004). A polyvinyl alcohol surface modifying additive (0.1 wt. % of powder) is added to aid dispersion. An extruded sheet is formed from the resulting powder. The sheet demonstrates magnetic properties.

### Example 6

This example describes using melt compounding to make highly dispersed and concentrated polymer magnetic composites according to the invention. About a 9:1 ratio of ground polymer (ZYLAR®-EX) and magnetic powder (iron oxide powder) with 0.1 wt. % surface modifying surfactant is added to a batch mixer at 200° C., mixed for 10 minutes, at 200 rpm and extruded to form a sheet. The resulting sheet has good mechanical integrity and demonstrates magnetic properties.

### Example 7

This example describes a synthetic approach to manufacture magnetic composites according to the invention using suspension polymerization techniques. An aqueous dispersion of magnetic particles (iron oxide, 100 mg in 15 ml water) and surfactants (100 mg in 5 ml water) are sonicated for 15 minutes and exposed to high shear mixing for another 15 minutes. The magnetic and surface modifier solutions are mixed and sonicated another 15 minutes. The mixture of magnetic particle/surface modifier aqueous solutions is added to a 2 wt. % aqueous solution of polyvinylalcohol. Styrene monomer, 25 g, and 0.16 g of benzoyl peroxide initiator are added to the mixture. The system is closed, purged using nitrogen and stirred at 250 rpm. The temperature is raised to 95° C. and polymerization is carried out for 6 hours. The resulting polymer beads are recovered by filtering and successive washes using water and methanol. The beads are extruded to form a sheet, which demonstrates magnetic properties.

### Example 8

This example describes using mechanical milling to make highly dispersed and concentrated polymer magnetic composites according to the invention. About a 9:1 ratio of ground polymer (DYLARK® 238, styrene maleic anhydride copolymer available from NOVA Chemicals Inc., Pittsburgh, Pa.) to magnetic powder (iron oxide powder) is added to a stainless steel crucible containing stainless steel balls. The weight ratio of stainless steel balls to powder (polymer and magnetic) is about 14:1. Ball milling is conducted for 8 hours, and is stopped every 15 minutes for 15 minutes and then re-started to avoid overheating the sample as generally described in Mat. Sci. Eng. B, 113, 228-235 (2004). A polyvinyl alcohol surface modifying additive (0.1 wt. % of powder) is added to aid dispersion. An extruded sheet is formed from the resulting powder. The sheet demonstrates magnetic properties.

The present invention has been described with reference to specific details of particular embodiments thereof. It is not intended that such details be regarded as limitations upon the scope of the invention except insofar as and to the extent that they are included in the accompanying claims.

We claim:

1. A storage container comprising:
a box comprising components that include a bottom tray and a cover, said cover being movable between alternative open and closed positions relative to said bottom tray, wherein at least a portion of at least one of the components comprises a composite material that includes:
a resin comprising a polymer obtained by polymerizing a monomer mixture that contains at least one polymerizable monomer; and
a magnetic material.

2. The storage box according to claim 1, wherein the polymerizable monomer is selected from the group consisting of vinyl aromatic monomers; C₂ to C₂₂ linear or branched olefins; C₁ to C₂₂ linear, cyclic or branched esters of (meth)acrylic acid; maleic acid, its anhydride or mono- or di- C₁ to C₂₂ linear, cyclic or branched esters thereof; maleimide, itaconic acid, its anhydride or mono- or di- C₁ to C₂₂ linear, cyclic or branched esters thereof; fumaric acid or mono- or di- C₁ to C₂₂ linear, cyclic or branched esters thereof; C₄ to C₂₂ linear, branched, or cyclic conjugated dienes, (meth)acrylonitrile and combinations thereof.

3. The storage box according to claim 1, wherein the resin comprises an elastomeric polymer.

4. The storage box according to claim 3, wherein the elastomeric polymer is selected from the group consisting of homopolymers of butadiene or isoprene; random, block, AB diblock, or ABA triblock copolymers of a conjugated diene with an aryl monomer and/or (meth)acrylonitrile; natural rubber; and combinations thereof.

5. The storage box according to claim 3, wherein the elastomeric polymer comprises one or more block copolymers selected from the group consisting of diblock and triblock copolymers of styrene-butadiene, styrene-butadiene-styrene, styrene-isoprene, styrene-isoprene-styrene, ethylene-vinyl acetate, partially hydrogenated styrene-isoprene-styrene, and combinations thereof.

6. The storage box according to claim 2, wherein the olefins comprise homopolymers, copolymers, and/or block copolymers containing repeat units resulting from the polymerization of one or monomers selected from the group consisting of ethylene, propylene, 1-butene, isobutylene, 2-butene, diisobutylene, 1-pentene, 2-pentene, 1-hexene, 2-hexene, 1-octene, 2-octene, 3-octene, and combinations thereof.

7. The storage box according to claim 2, wherein the vinyl aromatic monomers are selected from the group consisting of styrene, p-methyl styrene, α-methyl styrene, tertiary butyl styrene, dimethyl styrene, nuclear brominated or chlorinated derivatives thereof and combinations thereof.

8. The storage box according to claim 3, where the resin comprises a continuous phase containing the polymer and a dispersed phase containing the elastomeric polymer.

9. The storage box according to claim 1, wherein the magnetic material comprises one or more compounds containing atoms or molecules selected from the group consisting of Fe, Co, Ni, Cd, Cr, Mo, Mn, W, V, Nb, Ta, Ce, Pr, Nd, Pm, Sm, Eu, Gd, Tb, Dy, Ho, Er, Tm, Yb, Lu, alloys thereof, and combinations thereof.

10. The storage box according to claim 9, wherein the magnetic material is selected from the group consisting of a magnetite, a macchiemite, a goethite a ferrite and combinations thereof.

11. The storage box according to claim 9, wherein the magnetic material further comprises boron, silicon, nitrogen, and/or oxygen.

12. The storage box according to claim 1, wherein the magnetic material is present at a level of from about 0.001 to about 25 weight percent of the composite material.

13. The storage box according to claim 1, wherein the magnetic material is present at a level sufficient to allow the storage box to be detected when it enters a magnetic field or interrogation zone.

14. The storage box according to claim 1, wherein the composite material comprises at least one styrene based polymer and the magnetic material comprises a silicon, cobalt, nickel, and/or iron containing alloy.

15. The storage box according to claim 1, wherein the magnetic material is incorporated in the composite material as micron-sized and/or nano-sized powders.

16. The storage box according to claim 1, wherein the composite material is prepared by a suspension polymerization comprising
surface modifying particles comprising the magnetic material;
combining the surface modified particles with a monomer composition comprising styrene, and a polymerization initiator to provide a polymerization mixture;
polymerizing the polymerization mixture to provide a suspension of composite beads; and
recovering the composite beads.

17. A composite material comprising:
a resin comprising a polymer obtained by polymerizing a monomer mixture that contains at least one polymerizable monomer; and
a magnetic material dispersed within said resin;
wherein the magnetic material is present at a level sufficient to allow the material to be detected when it enters a magnetic field or interrogation zone.

18. A thermoplastic sheet formed from the composite material according to claim 17.

19. The thermoplastic sheet according to claim 18 formed by extruding the composite material into a sheet.

20. The thermoplastic sheet according to claim 18 formed using one or more of a single-screw extruder and a twin-screw extruder.

21. The thermoplastic sheet according to claim 18 having a thickness of from about 0.05 mm to about 10 mm.

22. The thermoplastic sheet according to claim 18 comprising one or more substrate layers of the thermoplastic sheet and one or more layers comprising another thermoplastic material.

23. An article formed by thermoforming the thermoplastic sheet according to claim 18.

24. The article according to claim 22, wherein the article is a package adapted to contain jewelry, watches, electronics, computers, stereo equipment, video equipment, compact disks or digital video disks.

25. A method of interrogating a magnetic tag or marker within a predetermined interrogation zone comprising
subjecting the magnetic tag sequentially to:
(1) a magnetic field sufficient in field strength to saturate the magnetic tag, and
(2) a magnetic null;
wherein the magnetic tag comprises the composite material according to claim 17.
